(19) United States
(12) Patent Application Publication
(10) Pub. No.: US 2021/0303902 A1
(43) Pub. Date: Sep. 30, 2021

(54) IMAGE PROCESSING DEVICE, IMAGE PROCESSING METHOD, AND PROGRAM

(71) Applicant: NEC Corporation, Tokyo (JP)

(72) Inventor: Masahito SAKAI, Tokyo (JP)

(73) Assignee: NEC Corporation, Tokyo (JP)

(21) Appl. No.: 17/204,155

(22) Filed: Mar. 17, 2021

(30) Foreign Application Priority Data
Mar. 25, 2020 (JP) 2020-053665

(51) Int. Cl. G06K 9/46; G06K 9/32; G06K 9/52

(52) U.S. Cl. CPC G06K 9/4604; G06K 2209/03; G06K 9/52; G06K 9/3216

(57) ABSTRACT

An image processing device includes: at least one memory configured to store instructions; and at least one processor configured to execute the instructions to: calculate a feature amount of each of feature amount calculation ranges of a plurality of subdivisions set in a processing target range of a captured image obtained by capturing an image of a recognition object; and specify a plurality of feature amount calculation ranges capable of constituting vertices of a polygon among the feature amount calculation ranges as feature ranges based on the feature amount.

This application is based upon and claims the benefit of priority from Japanese patent application No. 2020-053665 filed on Mar. 25, 2020, the disclosure of which is incorporated herein in its entirety by reference.

### TECHNICAL FIELD

The present invention relates to an image processing device, an image processing method, and a program.

### BACKGROUND ART

A technology that recognizes the state of a recognition object captured in an image with higher accuracy is required. Japanese Unexamined Patent Application, First Publication No. 2009-75848 (hereinafter referred to as Patent Document 1) discloses a technology for reliably reading an indicated value of a meter as a related technology.

### SUMMARY

It is necessary to properly specify a feature range in an image to recognize a recognition object with high accuracy.

Therefore, an example object of the present invention is to provide an image processing device, an image processing method, and a program capable of solving the problem described above.

According to a first example aspect of the present invention, an image processing device includes: at least one memory configured to store instructions; and at least one processor configured to execute the instructions to: calculate a feature amount of each of feature amount calculation ranges of a plurality of subdivisions set in a processing target range of a captured image obtained by capturing an image of a recognition object; and specify a plurality of feature amount calculation ranges capable of constituting vertices of a polygon among the feature amount calculation ranges as feature ranges based on the feature amount.

According to a second example aspect of the present invention, an image processing method includes: calculating a feature amount of each of feature amount calculation ranges of a plurality of subdivisions set in a processing target range of a captured image obtained by capturing an image of a recognition object; and specifying a plurality of feature amount calculation ranges capable of constituting vertices of a polygon among the feature amount calculation ranges as feature ranges based on the feature amount.

Moreover, in a third example aspect of the present invention, a non-transitory computer-readable recording medium stores a program which causes a computer of an image processing device to execute: calculating a feature amount of each of feature amount calculation ranges of a plurality of subdivisions set in a processing target range of a captured image obtained by capturing an image of a recognition object; and specifying a plurality of feature amount calculation ranges capable of constituting vertices of a polygon among the feature amount calculation ranges as feature ranges based on the feature amount.

According to some example embodiment of the present invention, it is possible to properly specify a feature range in an image to recognize a recognition object with high accuracy.

### BRIEF DESCRIPTION OF THE DRAWINGS

FIG. 1 is a diagram which shows an outline of an image processing device according to an example embodiment of the present invention.

FIG. 2 is a diagram which shows a hardware configuration of the image processing device according to the example embodiment of the present invention.

FIG. 3 is a functional block diagram of the image processing device according to the example embodiment of the present invention.

FIG. 4 is a flowchart of the image processing device according to the example embodiment of the present invention.

FIG. 5 is a first diagram which shows an outline of processing of the image processing device according to the example embodiment of the present invention.

FIG. 6 is a second diagram which shows the outline of the processing of the image processing device according to the example embodiment of the present invention.

FIG. 7 is a diagram which shows a minimum configuration of the image processing device of the present invention.

FIG. 8 is a diagram which shows a processing flow of the image processing device according to the minimum configuration of the present invention.

### EXAMPLE EMBODIMENT

In the following description, an image processing device according to an example embodiment of the present invention will be described with reference to the drawings.

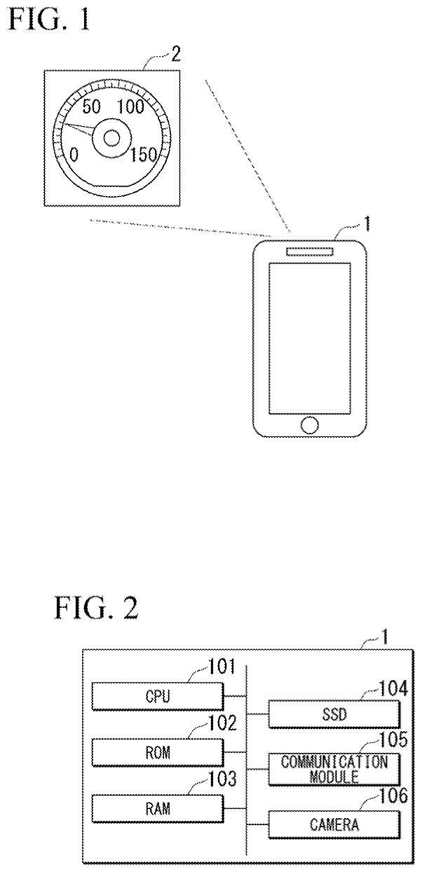

FIG. 1 is a diagram which shows an outline of the image processing device according to the present example embodiment.

As shown in FIG. 1, the image processing device 1 may be, for example, a device that functions as a mobile terminal such as a smart phone. The image processing device 1 includes a camera that captures a recognition object 2 such as an instrument, a clock, or a device, or characters printed on an instrument or the like. The recognition object 2 may be anything.

FIG. 2 is a diagram which shows a hardware configuration of the image processing device.

As shown in FIG. 2, the image processing device 1 is a computer that includes respective hardware such as a central processing unit (CPU) 101, a read only memory (ROM) 102, a random access memory (RAM) 103, a solid state drive (SSD) 104, a communication module 105, and a camera 106. The image processing device 1 may include other hardware constituents.

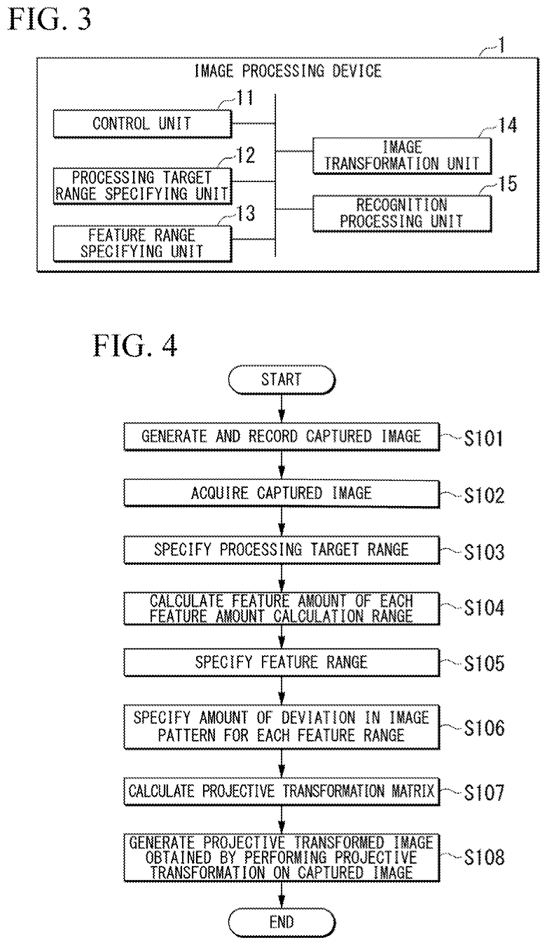

FIG. 3 is a functional block diagram of the image processing device.

The image processing device 1 exerts functions of a control unit 11, a processing target range specifying unit 12, a feature range specifying unit 13, an image transformation unit 14, and a recognition processing unit 15 by executing an image processing program.

The control unit 11 controls other functional units.

The processing target range specifying unit 12 specifies a processing target range related to a recognition object in an image obtained by capturing an image of the recognition object.

The feature range specifying unit 13 specifies a plurality of feature ranges that can form vertices of a polygon when the feature ranges are regarded as points on the basis of a feature amount (feature, feature value) of feature ranges included in the processing target range.

The image transformation unit 14 performs a projective transformation that brings the image of the recognition object closer to a regular image captured from in front of the recognition object.

The recognition processing unit 15 performs recognition processing for a state of the recognition object using a result of the projective transformation on the image obtained by capturing the recognition object.

An example when the image processing device 1 in the present example embodiment is a mobile terminal has been described, but it may also be a PC, a computer server, or the like. In this case, an image capturing device may generate the captured image of the recognition object 2 in the following description, and the PC or computer server may acquire the captured image from the image capturing device to perform the following processing. In the following description, the details of the processing of the image processing device will be described.

FIG. 4 is a flowchart of the image processing device.

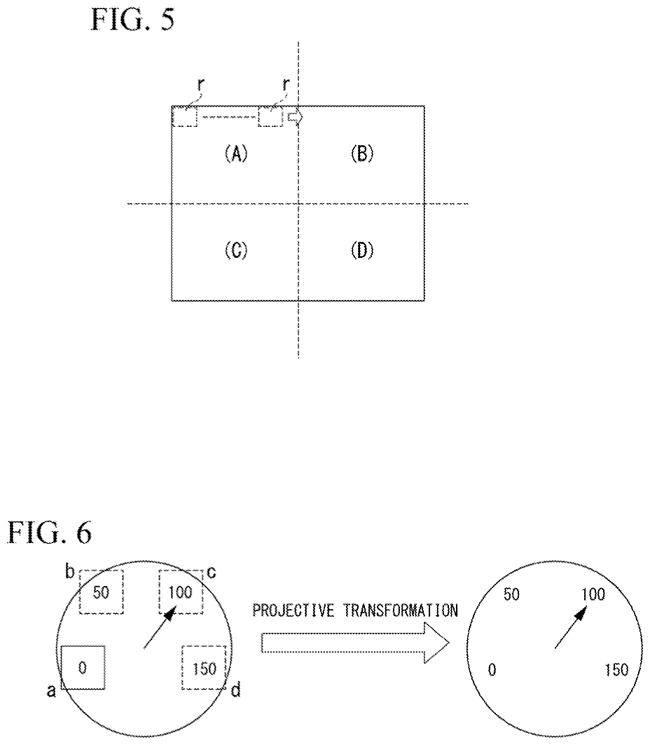

FIG. 5 is a first diagram which shows an outline of processing of the image processing device.

FIG. 6 is a second diagram which shows an outline of the processing of the image processing device.

First, a user operates the image processing device 1 and captures an image of the recognition object 2. The camera 106 of the image processing device 1 generates a captured image in a range including the recognition object 2 on the basis of the image capturing operation of the user, and records it in a storage unit such as the SSD 104 (step S101). The user instructs the image processing device 1 to start image processing of the recognition object 2. Then, the control unit 11 reads the captured image of the recognition object 2 and outputs the captured image to the processing target range specifying unit 12.

The processing target range specifying unit 12 acquires the captured image (step S102). Here, the processing target range specifying unit 12 may acquire a captured image obtained by the image transformation unit 14 first performing the projective transformation (first projective transformation) on this captured image into an image of the recognition object 2 visually recognized from the front. For example, a square mark is typed or printed on the recognition object 2. In this case, a new captured image may be used (obtained) by generating a projective transformation matrix such that a shape of the mark shown in the captured image becomes a square shape, and performing projective transformation on the captured image using this projective transformation matrix. This projective transformation matrix is calculated by, for example, a known calculation method for a homography transformation matrix using a deviation or a correlation value of each of four coordinate points of rectangular corners of the mark shown in the captured image and four coordinate points of corners of the corresponding positions in the mark determined in advance.

The regular image is an image of the recognition object 2 captured from the front. It is assumed that the captured image and the regular image are images obtained by capturing the image of the recognition object 2 from positions having substantially the same distances from the recognition object 2. In this case, a size of the recognition object 2 shown in the captured image and a size of the recognition object 2 shown in the regular image are substantially the same.

The processing target range specifying unit 12 specifies a processing target range of the recognition object 2 shown in the captured image (step S103). As an example, the processing target range is a range obtained by excluding an exclusion range other than the recognition object 2 shown in the captured image from the captured image. When the recognition object 2 is, for example, an instrument such as a clock, an analog meter, or a digital meter, the processing target range specifying unit 12 may specify only the inside of a board surface (such as a character board surface or a liquid crystal board surface) of a clock or an instrument as the processing target range. In addition, the processing target range specifying unit 12 may also specify a pointer of the clock or the instrument as the exclusion range. The processing target range specifying unit 12 may specify a range that matches the regular image by pattern matching or the like, and may specify this range as the processing target range. The processing target range specifying unit 12 may specify the processing target range using a method other than that described above. For example, the processing target range specifying unit 12 may also specify the processing target range using a machine learning method. The processing target range specifying unit 12 may be an image obtained by masking foreign matter (such as the mark described above) in the recognition object 2.

As shown in FIG. 5, the feature range specifying unit 13 sets a feature amount calculation range (feature calculation range, feature value calculation range) r of a subdivision in the processing target range, sets the feature amount calculation range r by shifting it by the predetermined number of pixels in a horizontal direction or a vertical direction, and sequentially calculates a feature amount (feature, feature value) of each set feature amount calculation ranger r (step S104). More specifically, the feature amount calculation range r is defined as a range smaller than the processing target range. Each feature amount calculation range r set in the captured image may overlap another feature amount calculation range r. The feature range specifying unit 13 calculates a feature amount (feature, feature value) of each pixel in the feature amount calculation range r on the basis of color information and edge information of each pixel included in the feature amount calculation range r. The feature range specifying unit 13 calculates the feature amount of each pixel in the feature amount calculation range r by using a known feature amount calculation method (feature calculation method) (AgastFeasture, AKAZE, BRISK, FAST, KAZE, MSER, ORB, SIFT, SURF, or the like). The feature range specifying unit 13 calculates the feature amount of the feature amount calculation range r by totaling or summing the feature amounts of each pixel included in the feature amount calculation range r.

The feature range specifying unit 13 sets a threshold value to a value of the largest feature amount among the feature amounts calculated for each feature amount calculation range r, and specifies a feature amount calculation range r corresponding to a plurality of feature amounts exceeding the threshold value as a feature range by gradually lowering the threshold value (step S105). The feature range specifying unit 13 may specify the feature range in the above-described captured image in which the recognition object 2 is shown, on the basis of a learning model obtained by performing machine learning on a relationship between an input and an output, which sets an image as the input and the feature range in the image as the output.

As an example, the feature range specifying unit 13 specifies four feature ranges. The feature range specifying unit 13 may specify three feature ranges in descending order of the feature amounts. Alternatively, the feature range specifying unit 13 may specify three feature ranges in descending order of the features. The feature range specifying unit 13 specifies a plurality of feature amount calculation ranges r that can constitute the vertices of a polygon as a feature range in features of the feature range described above. In specifying such a feature range, the feature range specifying unit 13 specifies, as a feature range, three or more feature amount calculation ranges r at the outer side as far as possible in the processing target range.

For example, when the feature range specifying unit 13 specifies four feature amount calculation ranges r as feature ranges, it may specify feature ranges one by one from each of areas A, B, C, and D (refer to FIG. 5) obtained by dividing the processing target range into four using straight lines drawn vertically and horizontally on the basis of the center.

Alternatively, for each of the areas A, B, C, and D, the plurality of feature amount calculation ranges r are specified in descending order of the feature amounts, and center coordinates indicated by these feature amount calculation ranges r are compared, and thereby one feature amount calculation range r, in which any one of an x coordinate or a y coordinate is closest to a coordinate indicating an outer frame of the processing target range of the feature amount calculation range r among these center coordinates, may be specified as a feature range. The feature range specifying unit 13 outputs the specified feature ranges to the image transformation unit 14.

The feature range specifying unit 13 may output a predetermined number of feature amount calculation ranges r each having a feature amount equal to or more than a threshold value to a display device (for example, a display of the image processing device 1) or the like on the basis of a relationship between the feature amount and the threshold value of each feature amount calculation range r, and receives a designation (selection information) of a feature amount calculation range r to be specified as a feature range from a user, thereby specifying a feature range. The processing is one example aspect of processing of outputting, by the feature range specifying unit 13, the feature amount calculation ranges to the display device, receiving an input of the selection information indicating feature amount calculation ranges selected by the user among the output feature amount calculation ranges, and specifying a plurality of feature amount calculation ranges capable of constituting the vertices of a polygon as feature ranges on the basis of the selection information. The feature range specifying unit 13 may output a plurality of feature amount calculation ranges close to the outer side in the processing target range to the display device, receives an input of selection information indicating feature amount calculation ranges selected by the user among the output feature amount calculation ranges, and specify a plurality of feature amount calculation ranges capable of constituting the vertices of a polygon as feature ranges on the basis of the selection information.

In the following description, description will proceed on an assumption that four feature ranges (a, b, c, and d of FIG. 6) are specified by the feature range specifying unit 13.

The image transformation unit 14 acquires coordinate information of four feature ranges. The image transformation unit 14 acquires the regular image of the recognition object 2 from the storage unit. The image transformation unit 14 specifies an amount of deviation between an image pattern included in the feature range specified in the processing target range in the captured image and an image pattern included in a range of a corresponding position in the regular image for each of the four feature ranges (step S106). For example, it is assumed that the processing target range of recognition object 2 is a board surface on which characters are typed, and the characters are printed in the feature range. In this case, the image transformation unit 14 assumes that a part of the characters (an image pattern) appears in the feature range. The image transformation unit 14 calculates the amount of deviation between a part of the characters appearing in the specified feature range in a processing target of the captured image and a part of characters appearing in a corresponding range of the regular image. This amount of deviation may be expressed by an amount of deviation in the vertical direction (the amount of deviation in an x-coordinate direction), the amount of deviation in the horizontal direction (the amount of deviation in a y-coordinate direction), a rotational angle, and the like.

The image transformation unit 14 calculates a projective transformation matrix by a known calculation method for a homography transformation matrix using the amounts of deviation calculated for each of the four feature ranges (step S107). The image transformation unit 14 may calculate the projective transformation matrix by a known calculation method of an affine transformation matrix using an amount of deviation related to the features (numbers) of any three of the four feature ranges dispersed in the recognition object 2.

The image transformation unit 14 generates a projective transformation image obtained by performing a projective transformation on a captured image showing the recognition object 2 using a projective transformation matrix (step S109). When the first projective transformation using the mark described above is performed, this transformation becomes a second projective transformation. The image transformation unit 14 outputs the projective transformation image to the recognition processing unit 15. It is assumed that the recognition object 2 shown in the captured image is an analog meter containing a pointer. The recognition processing unit 15 calculates, on the basis of the position of the scale indicated by the pointer in the projective transformation image, a numerical value that is stored corresponding to that position of the scale, by using interpolation calculation or the like. The image transformation unit 14 outputs the numerical value corresponding to the position of the scale indicated by the pointer. For example, an output destination is a liquid crystal display, and the recognition processing unit 15 outputs the numerical value of the scale indicated by the pointer to the liquid crystal display.

According to the processing described above, the image processing device 1 performs the projective transformation such that a recognition object shown in the captured image is in a state of being captured from the front in the same manner as a recognition object shown in the regular image. The image processing device 1 can specify feature ranges on the basis of a feature amount of the recognition object shown in the captured image, which is suitable for calculating a projective transformation matrix for this projective transformation. As these feature ranges, a plurality of feature amount calculation ranges capable of constituting the vertices of a polymer are specified. Therefore, it is possible to specify three or more feature ranges capable of constituting the vertices of a polygon, which are for calculating a projective transformation matrix used for the projective transformation.

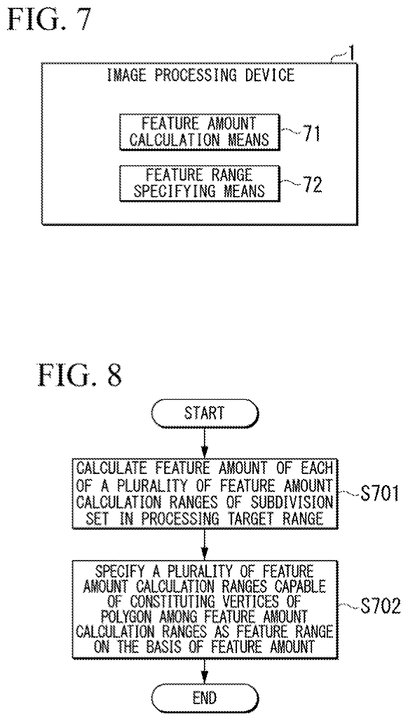

FIG. 7 is a diagram which shows a minimum configuration of the image processing device.

FIG. 8 is a diagram which shows a processing flow of the image processing device according to the minimum configuration.

As shown in FIG. 8, the image processing device 1 may be a device that exerts at least functions of a feature amount calculation means 71 and a feature range specifying means 72.

The feature amount calculation means 71 calculates the feature amount of each of the plurality of feature amount calculation ranges of a plurality of subdivisions set in the processing target range in the captured image of the recognition object (step S701).

The feature range specifying unit 72 specifies a plurality of feature amount calculation ranges that are capable of constituting the vertices of a polygon among the feature amount calculation ranges as feature ranges on the basis of the feature amount (step S702).

The image processing device described above has a computer system inside. Each of the processes described above is stored in a computer-readable recording medium in a form of a program, and the processing described above is performed by a computer reading and executing this program. Here, the computer-readable recording medium refers to a magnetic disk, a magneto-optical disc, a CD-ROM, a DVD-ROM, a semiconductor memory, or the like. In addition, this computer program may be distributed to a computer via a communication line, and the computer receiving this distribution may execute the program.

In addition, the program described above may be a program for realizing some of the functions described above.

Furthermore, it may also be a so-called difference file (a difference program) that can realize the functions described above in combination with a program already recorded in the computer system.

What is claimed is:

1. An image processing device comprising:
at least one memory configured to store instructions; and
at least one processor configured to execute the instructions to:
calculate a feature amount of each of feature amount calculation ranges of a plurality of subdivisions set in a processing target range of a captured image obtained by capturing an image of a recognition object; and
specify a plurality of feature amount calculation ranges capable of constituting vertices of a polygon among the feature amount calculation ranges as feature ranges based on the feature amount.

2. The image processing device according to claim 1,
wherein the processor is further configured to execute the instructions to specify the plurality of feature amount calculation ranges capable of constituting the vertices of the polygon in descending order of the feature amount as the feature ranges.

3. The image processing device according to claim 1,
wherein the processor is further configured to execute the instructions to specify a plurality of feature amount calculation ranges close to an outer edge of the processing target range as the feature ranges.

4. The image processing device according to claim 1,
wherein the processor is further configured to execute the instructions to:
output the feature amount calculation ranges to a display device,
receive an input of selection information indicating feature amount calculation ranges selected by a user among the output amount feature calculation ranges; and
specify the plurality of feature amount calculation ranges capable of constituting the vertices of the polygon based on the selection information as the feature ranges.

5. The image processing device according to claim 1,
wherein the recognition object is a board surface of an analog meter, and
the processor is further configured to execute the instructions to perform projective transformation that approximate the recognition object to a regular image captured from front by using information related to the plurality of feature ranges capable of constituting the vertices of the polygon.

6. An image processing method comprising:
calculating a feature amount of each of feature amount calculation ranges of a plurality of subdivisions set in a processing target range of a captured image obtained by capturing an image of a recognition object; and
specifying a plurality of feature amount calculation ranges capable of constituting vertices of a polygon among the feature amount calculation ranges as feature ranges based on the feature amount.

7. A non-transitory computer-readable recording medium storing a program which causes a computer of an image processing device to execute:
calculating a feature amount of each of feature amount calculation ranges of a plurality of subdivisions set in a processing target range of a captured image obtained by capturing an image of a recognition object; and
specifying a plurality of feature amount calculation ranges capable of constituting vertices of a polygon among the feature amount calculation ranges as feature ranges based on the feature amount.
